(19) United States
(12) Patent Application Publication
(10) Pub. No.: US 2007/0280159 A1
(43) Pub. Date: Dec. 6, 2007

(54) Load-Sharing Method And System In A Wireless Base Station

(75) Inventors: Sheng Liu, Shenzhen (CN); Baijun Zhao, Shenzhen (CN); Huang Bill, Shenzhen (CN)

Correspondence Address: SEED INTELLECTUAL PROPERTY LAW GROUP PLLC, 701 FIFTH AVE, SUITE 5400, SEATTLE, WA, 98104, US

(73) Assignee: UTStarcom Telecom Co., LTD, Hangzhou City (CN)

(21) Appl. No.: 10/591,854

(22) PCT Filed: Mar. 4, 2004
(86) PCT No.: PCT/CN04/00174

§ 371 Date: Jun. 14, 2007

(51) Int. Cl. H04L 7/00

(52) U.S. Cl. 370/330

(57) ABSTRACT

The invention provides a wireless base station connected to a wireless network control device, another wireless base station and a subscriber unit, comprising a first communication device for receiving/transmitting downlink data frames/uplink data frames from/to the wireless network control device; a second communication device for transmitting/receiving downlink wireless signals/uplink wireless signal to/from the subscriber unit; a channel processing device for processing the downlink data frames/uplink wireless signals into downlink wireless signals/uplink data frames; and a signal distribution unit for supplying the downlink data frames and the uplink wireless signals to the channel processing device for processing, wherein the base station further comprising a third communication device for communicating with the another base station, and the signal distribution unit further comprising forwarding control means for transmitting the downlink data frames or uplink wireless signals to the another wireless base station and receiving corresponding downlink wireless signals or uplink data frames from the another wireless base station, through the third communication device.

### TECHNICAL FIELD

The present invention relates to the communication field, and particularly relates to a method of sharing the load of a base station in a mobile communication system.

### BACKGROUND TECHNOLOGY

In the mobile communication system, the transmission, reception and processing of the wireless signals are performed by base stations (BTS). As shown in FIG. 1(a), a conventional BTS is mainly composed by a baseband processing subsystem, a radio frequency (RF) subsystem and an antenna, and one BTS may cover different cells through the RF antenna. As shown in FIG. (1b), BTSs are connected to a base station controller (BSC) or wireless networks controller (RNC) respectively through a certain interface, and in a WCDMA (wideband code division multiple access) system, for example, the interface is Iub interface.

In the traditional BTS system, since the baseband processing subsystem, RF subsystem and antenna are geographically located together, therefore each cell must be equipped with enough channel processing resources to fulfill each cell's peak traffic, and therefore needs a higher cost. To solve this problem, there is proposed a BTS structure with a low cost, a centralized BTS system based on remote antenna units, and more implementation details were disclosed in PCT patent WO9005432 “Communications system”, U.S. Pat. No. 5,657,374 “Cellular system with centralized base stations and distributed antenna unit”, U.S. Pat. No. 6,324,391 “Cellular communication with centralized control and signal processing”, China patent CN1211889 “duplex open air BTS transceiver subsystem using a hybrid system”, and United States Patent application US20030171118 “Cellular radio transmission apparatus and cellular radio transmission method”.

As shown in FIG. 2, existing centralized BTS system 200 based on remote antenna units are composed of a central channel processing subsystem 21 and remote antenna units 22 which are installed as centralized. The central channel processing subsystem 21 mainly comprises functional units such as channel processing resource pool 23, signal distribution unit 25, line interface unit 26 and etc., wherein the channel processing resource pool 23 is formed by stacking a plurality of channel processing units 24, and performs tasks such as baseband signal processing of cells possessed by the BTS, and the signal distribution unit 25 dynamically allocates channel processing resources according to conditions of actually active users of different cells to realize effective sharing of the processing resources among multiple cells. The remote antenna units 22 are mainly constituted by the transmission channel's radio frequency power amplifier, the reception channel's low noise amplifier, an antenna and etc. The links between the central channel processing subsystem 21 and the remote antenna units 22 may adopt transmission medium such as optical fiber, coaxial cable, microwave and etc.; the signal transmission may be done by way of digital signals after sampling, or simulating signals after modulating; the signals may be baseband signals, intermediate frequency signals or radio-frequency signals. For technologies for dynamically allocating channel processing resources, please refer to U.S. Pat. No. 6,353,600 “Dynamic sectorization in CDMA employing centralized base-station architecture”, U.S. Pat. No. 6,594,496 “Adaptive capacity management in a centralized base station architecture” and etc.

However, for the centralized BTS system adopting remote antenna units and implemented according to existing techniques, there is still a certain channel processing resource allocation problem, As noted earlier, in the centralized BTS system adopting remote antenna units, since the reusing of the channel processing resources by multiple cells, the actual total amount of the channel processing resources may be less than the total peak traffic of all the cells. For example, a centralized BTS system supports maximal 10 remote antenna units, each of which corresponds to one cell. Suppose that each cell's peak traffic is equivalent to 96 service channels, the total peak traffic of all the cells is equivalent to 960 service channels. In consideration of reuse of the processing resources, the number of the actually configured channel processing units is less than the total peak traffic. Thus, when all the cells in a centralized BTS system reach to a very high traffic, the centralized BTS system's channel processing resources will not be able to fulfill the actual traffic demand, thereby causing call loss which impacts the quality of service.

Although increasing the amount of the centralized BTS system's channel processing resources may reduce the occurrence frequency of this problem, it counteracts the centralized BTS system's advantage of higher resource utilization resulted from the reuse of the channel processing resources by multiple cells, and therefore, for this problem, the present invention propose a method which allows for adopting as low as possible configured channel processing resources, and at the same time, is able to avoid call loss caused by inadequate resources.

### SUMMARY OF THE INVENTION

An object of the present invention is to provide a method which allows for adopting as low as possible configured channel processing resources, and at the same time, is able to avoid call loss caused by inadequate resources, so as to optimize the wireless base station system's resource allocation and solve the above problem.

According to a aspect of the present invention, there is provided a wireless base station which is operatively connected to a wireless network control device, another wireless base station and a subscriber unit, comprising: a first communication device for receiving downlink data frames from the wireless network control device and transmitting uplink data frames to the wireless network control device; a second communication device for transmitting downlink wireless signals to the subscriber unit and receiving uplink wireless signals from the subscriber unit; a channel processing device for processing the downlink data frames into the downlink wireless signals and processing the uplink wireless signals into the uplink data frames; and a signal distribution unit for supplying the downlink data frames and the uplink wireless signals to the channel processing device for processing, characterized in that, the wireless base station further comprising a third communication device for communicating with the another wireless base station, and the signal distribution unit further comprising: forwarding control means for transmitting the downlink data frames or uplink wireless signals to the another wireless base station and receiving corresponding downlink wireless signals or uplink data frames from the another wireless base station, through the third communication device.

According to another aspect of the present invention, there is further provided a wireless base station system comprising a first base station, a second base station and a wireless network control device, the first base station comprising: a first communication device for receiving downlink data frames from the wireless network control device and transmitting uplink data frames to the wireless network control device; a second communication device for transmitting downlink wireless signals to the subscriber unit and receiving uplink wireless signals from the subscriber unit; a channel processing device for processing the downlink data frames into the downlink wireless signals and processing the uplink wireless signals into the uplink data frames; and a signal distribution unit for supplying the downlink data frames and the uplink wireless signals to the channel processing device for processing, characterized in that, the first base station further comprising a third communication device for communicating with the second base station, and the signal distribution unit further comprising: forwarding control means for transmitting the downlink data frames or uplink wireless signals to the second base station and receiving corresponding downlink wireless signals or uplink data frames from the second base station, through the third communication device.

According to another aspect of the present invention, there is provided a communication method in a wireless base station which is operatively connected to a wireless network control device, another wireless base station and a subscriber unit, the wireless base station comprising a first communication device, a second communication device, a channel processing device and a signal distribution unit, the method comprising steps: receiving downlink data frames from the wireless network control device through the first communication device; transmitting uplink data frames to the wireless network control device through the first communication device; transmitting downlink wireless signals to the subscriber unit through the second communication device; receiving uplink wireless signals from the subscriber unit through the second communication device; supplying through the signal distribution unit the downlink data frames and the uplink wireless signals to the channel processing device for processing; and processing the downlink data frames into the downlink wireless signals and processing the uplink wireless signals into the uplink data frames in the channel processing device, wherein the wireless base station further comprising a third communication device for communicating with the another wireless base station, and the method is characterized in that the providing step further comprising: transmitting the downlink data frames or the uplink wireless signal to the another wireless base station through the third communication device; and receiving corresponding downlink wireless signals or uplink data frames from the another wireless base station through the third communication device.

According to another aspect of the present invention, there is provided a communication method in a wireless base station system, the wireless base station system comprising a first base station, a second base station and a wireless network control device, the first base station comprising a first communication device, a second communication device, a channel processing device and a signal distribution unit, wherein in the first base station: receiving downlink data frames from the wireless network control device through the first communication device; transmitting uplink data frames to the wireless network control device through the first communication device; transmitting downlink wireless signals to the subscriber unit through the second communication device; receiving uplink wireless signals from the subscriber unit through the second communication device; supplying through the signal distribution unit the downlink data frames and the uplink wireless signals to the channel processing device for processing; and processing the downlink data frames into the downlink wireless signals and processing the uplink wireless signals into the uplink data frames in the channel processing device, wherein the first base station further comprising a third communication device for communicating with the second base station, and the method is characterized in that the providing step further comprising: in the first base station, transmitting the downlink data frames or the uplink wireless signals to the second wireless base station through the third communication device; and in the first base station, receiving corresponding downlink wireless signals or uplink data frames from the second base station through the third communication device.

In an alternative embodiment of the present invention, there are wideband link interfaces between the BTSs. The local BTS connects to a remote end BTS through the above wideband link interface. The wideband link interface comprises a link layer function such as multiplexing/demultiplexing and etc., and a physical link interface. In the present invention, an improved signal distribution unit switches some wireless signals directly to the wideband link interface to share excessive processing loads by another remote end BTS system, thereby avoiding the call loss caused by inadequate resources of the centralized BTS system.

The present invention's advantages also include the ability to realize high usability of the base station system, i.e., when a part or all of a BTS's channel processing resources fail to work, the technology is still able to guarantee the user's access.

### DESCRIPTION OF THE DRAWINGS

The above and/or other aspects, features and/or advantages of the present invention will be further appreciated in view of the following description in conjunction with the accompanying figures, wherein:

FIG. 1(a) is a diagram showing the structure of a conventional BTS system; FIG. 1(b) is a diagram showing the conventional network structure of the BTS and BSC/RNC;

FIG. 2 is a diagram showing the structure of a centralized BTS system adopting remote end antenna units;

FIG. 3 is a diagram showing the structure of a centralized BTS system supporting processing resource sharing and load-sharing;

FIG. 4(a) is a diagram showing an uplink and downlink signal distributing manner according to one embodiment of the present invention;

FIG. 4(b) is a diagram showing an uplink and downlink signal distributing manner according to another embodiment of the present invention;

FIG. 5 is a diagram showing the structure of a conventional BTS system supporting processing resource sharing and load-sharing;

FIG. 6 is a diagram showing the information transmission between BTS interfaces based on load-sharing;

FIG. 7 is a diagram showing user plane data/signal flow of a BTS based on load-sharing; and

FIG. 8 shows one embodiment of structure of the network based on load-sharing.

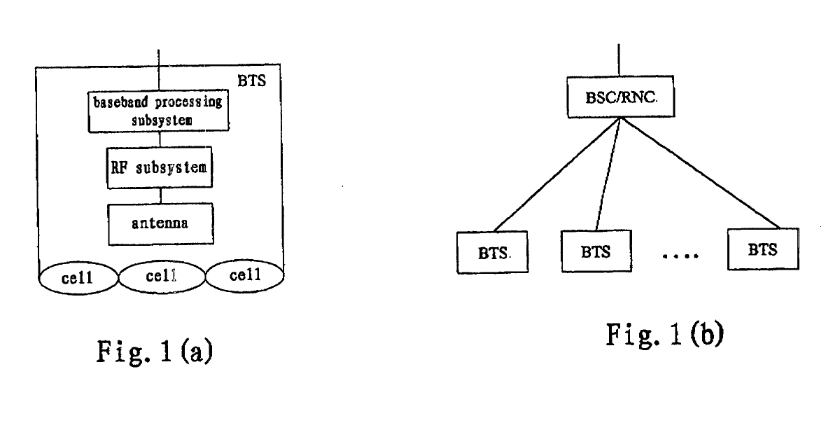

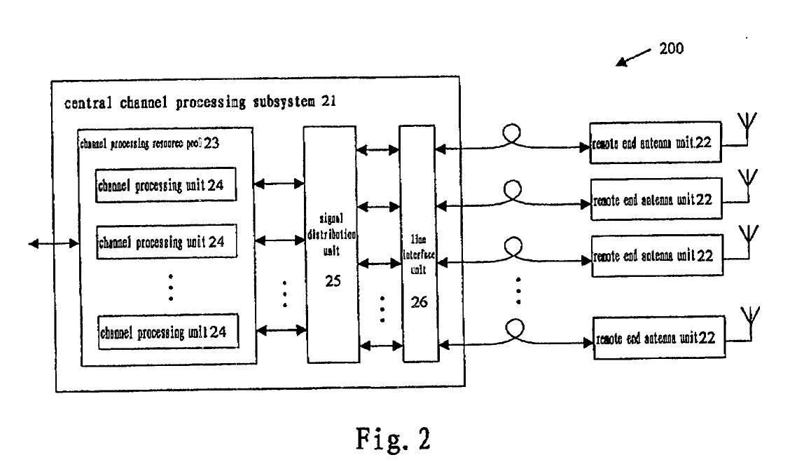

### DETAILED DESCRIPTION OF THE PREFERRED EMBODIMENTS

The base station and method of the present invention will be described in detail by referring to the accompanying drawings, wherein since the present invention's method relates to cooperating of BSC/RNC and BTSs, the method steps of the present invention will be described in connection with the explanation of BSC/RNC and BTS.

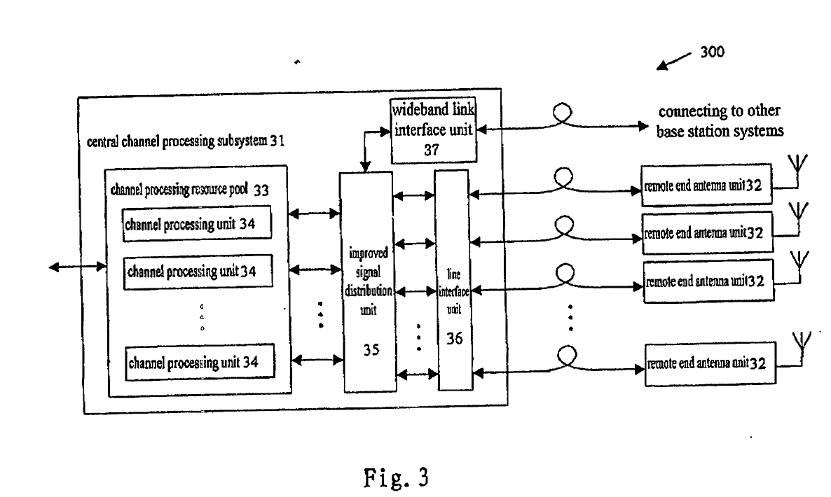

FIG. 3 shows a centralized base station system 300 supporting processing resource sharing and load-sharing according to the present invention. As compared to the conventional base station system, central channel processing subsystem 31 has an improved signal distribution unit 35, and adds a link interface 37 for connecting to other base station(s). Thus, the solution allows the centralized base station system to be configured with less channel processing resources, wherein when the channel processing resources' occupation rate reaches to a certain upper limit, or according to scheduling policies such as load balancing and etc., or when a fault occurs, the improved signal distribution units 35 will directly switch signals, to which some traffic channels belong, to the wideband link interface 37 connected to the other base station(s), so that the other remote end base station system(s) can share given processing loads, thereby avoiding call loss caused by the centralized base station system's inadequate resources.

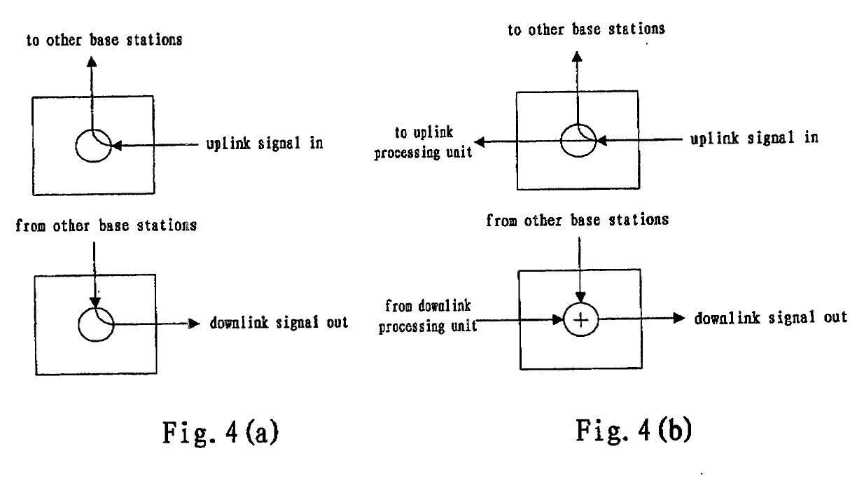

Taking a WCDMA system for example, the uplink signals from one cell include a plurality of uplink physic channels undergone the uplink complex scrambling and spreading, and when adopting the signal distribution manner as shown in FIG. 4 (b), the uplink signals are distributed to the local BTS's uplink processing unit and other BTS(s) at the same time, and the local BTS and the remote end BTS(s) respectively perform a respective portion of uplink physic channel processing on the uplink signals, including matching filtering, despreading, channel estimating, RAKE merging, signal-interference ratio (SIR) estimating, deinterleaving, channel decoding and etc. On the other hand, the downlink signals of one cell are obtained by code-division multiplexing a plurality of downlink physic channels spread by an orthogonal variable spreading factor code, and therefore the local BTS and the remote end BTS(s) may respectively perform a portion of downlink physic channel processing on the downlink signals, including channel encoding, interleaving, rate matching, spreading, scrambling, modulating, waveform shaping filtering and etc., and then the respective generated portions of downlink physic channels are added to generate the cell's downlink signals. FIG. 4(a) shows another embodiment of signal distribution manner adopted by the present invention, wherein a certain cell's channel processing job is wholly transferred to other base station(s)

Since there is a certain connection between the uplink and downlink signals, for example in the WCDMA system, uplink and downlink physic channels satisfy a certain timing relation, and the generation and processing of some control commands of the physical layer, such as power control command (TPC), feedback indication in the closed loop transmission diversity and site selection diversity transmission (SSDT), and etc., both require that the processing of the uplink and downlink physic channels is performed by the same BTS. Therefore, when adopting the signal distribution manner as shown in FIG. 4(a), 4(b) in the present invention, it is preferable to distribute the same pair of uplink and downlink physic channels to the same BTS for processing.

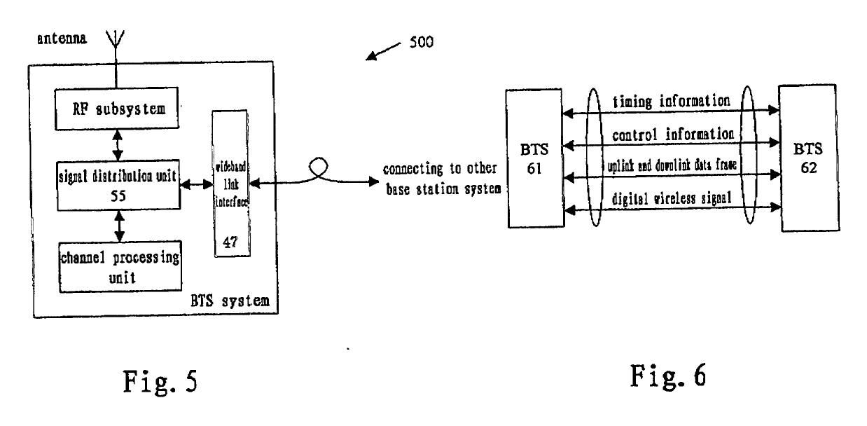

In the present invention, the benefit of adopting the signal distribution manner as shown in FIG. 4(a), 4(b) consists in that, instead of completing channel processing of a cell by the cell's base station in the existing techniques, it is allowed to use available processing resources of other base station(s) to share the cell's channel processing, and flexibly divide signals of the same cell according to the usability of processing resources, thereby reducing the likelihood of wasting processing resources in the system, and increasing the utilization ratio of processing resources. In addition, the present invention do not restrict the number of remote end BTS(s) for load-sharing, allowing a plurality of remote end BTSs providing available processing resources at the same time, thereby increasing the system's flexibility. Besides the advantage of increasing resource utilization ratio due to the load-sharing, the present invention provides another benefit of high usability, i.e., when a part or all of a BTS's channel processing resources fail to work, the remote end BTS(s) are allowed to provide it with processing resources by adopting the present invention's technique, thereby implementing the system's high usability. Therefore, although the present invention's load-sharing technique is proposed based on the optimization of the centralized BTS's channel processing resource configuration, but really the technique can also be applicable to conventional BTSs as shown in FIG. 5.

According to a preferable embodiment of the present invention, the wideband link interface connected to the remote end BTS (s) comprises link layer functions such as multiplexing/demultiplexing and etc., and a physical link interface such as photoelectric conversion and electrooptical conversion module, light transceiver and etc. when using optical fiber. FIG. 6 is a diagram showing the information transmission between BTS interfaces based on load-sharing. As shown in FIG. 6, besides transmitting uplink and downlink cell wireless signals distributed based on load-sharing, at least the following information need be transmitted: cell timing synchronization information; downlink data frames from the BSC/RNC which are forwarded by local BTS 61, and uplink data frames returned to local BTS 61 which are formed after being processed by remote end BTS 62; uplink wireless signals from the cell which are forwarded by local BTS 61, and downlink wireless signals returned to local BTS 61 which are formed after being processed by remote end BTS 62; as well as the control information between local BTS 61 and remote end BTS 62. Since the wideband link has to transmit not only uplink and downlink cell wireless signals distributed based on load-sharing, but also the cell timing synchronization information, uplink and downlink data frames, the control information between the BTSs and etc., it is therefore preferable to transmit the uplink and downlink cell wireless signals distributed based on load-sharing in digital manner, thereby facilitating the transmission of the information in the same link. In consideration of limitation on the link band width, it is preferable to employ digital baseband signals or digital intermediate frequency signals to perform the transmission, or preferable to employ the wideband link. However, these measures are not prerequisite, and can be selected according to specific needs.

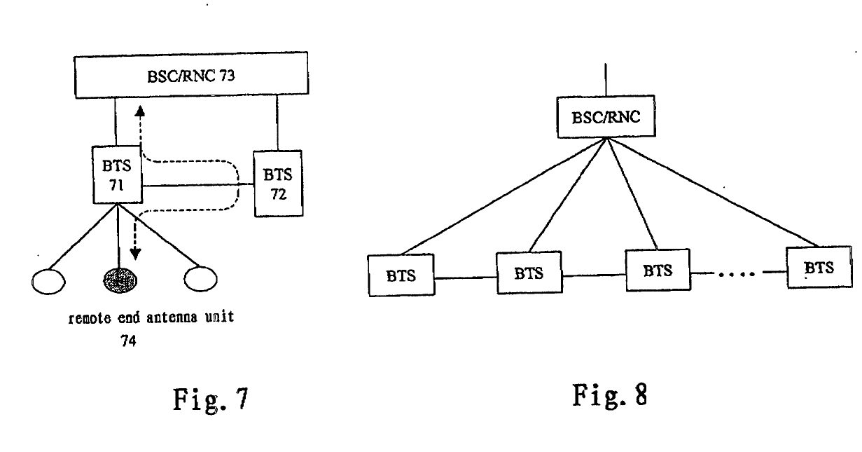

FIG. 7 is a diagram showing user plane data/signal flow of a BTS based on load-sharing. The data transmission routing between BTS 71 and BTS 72 of the present invention as shown in FIG. 7 is described as follows. In the downlink direction, the downlink data frames from BSC/RNC 73 are forwarded to remote end BTS 72 by local BTS 71, are used by remote end BTS 72 to generate a part or all of downlink physic channels of a designated cell and to form baseband or intermediate frequency digital signals, which are transmitted to local BTS 71 via the wideband link between local BTS 71 and remote end BTS 72, and to form down link wireless signals of the cell in local BTS 71, which are sent out through antenna 74; in the uplink direction, uplink wireless signals of a designated cell which are received by antenna 74 are routed to remote end BTS 72 via the signal distribution unit of local BTS 71 and the wideband link, undergoes the baseband processing by remote end BTS 72 to form uplink data frames, which are returned to local BTS 71 by remote end BTS 72 via the wideband link, and finally are transferred to BSC/RNC 73 by local BTS 71.

For the convenience of specific description, the specific implementation procedure of the present invention will be described by taking a WCDMA FDD system as an example. In the WCDMA system, each BTS, i.e., node B (NodeB) has a local frame timer (BFN) to which the system frame timing (SFN) of the cell the BTS belongs to is identical, SFN and BFN are at a range of 0˜4095 frames, all the wireless channels of the cell are established with this as a reference (see protocols such as TS25.402, TS25.211 and etc. for more details).

According to the above, when a part or all of signals of a cell the local NodeB belongs to are distributed to the remote end NodeB via the wideband link between the NodeBs for processing, in order for the remote end NodeB to be able to correctly receive and transmit the cell's wireless signals, the local NodeB should transfers its BFN/SFN timing information to the remote end NodeB, thus the remote end NodeB is able to obtain the correct timing.

To guarantee the down link orthogonality, when using the signal distribution manner as shown in FIG. 4 (b), the wireless signals from the remote end NodeB and the local NodeB of the same cell should be exactly aligned in timing. To this end, according to the present invention, in the downlink direction, the timing of the downlink wireless signals generated by the remote end NodeB should have a certain preact which should be equal to or greater than the delay of wideband transmission link between NodeBs, so that when the local NodeB receives a portion of wireless signals of the cell from the remote end NodeB, the wireless signals are able to (if required, after being buffered) be aligned to the timing of the remaining wireless signals of the cell generated by the local NodeB, and to be transmitted with the same frame timing. As to the downlink direction using the signal distribution manner as shown in FIG. 4(a), although the remote end NodeB directly produce all the downlink wireless signals of a cell to guarantee the orthogonality, to compensate the transmission delay of the wideband transmission link between the NodeBs, a timing preact is also needed, wherein the timing preact should equal to the delay of the wideband transmission link between the NodeB. As stated above, the preact may also be greater than the delay.

For implementing the processing resource sharing and load-sharing according to the present invention between the BTSs, the interface between the NodeB should transmit control signaling and user plane data frames between the NodeBs, wherein the control signaling between the NodeBs includes operating commands such as processing resource query, distribution control, establishment, modification, release and etc. The processing resource query command is used to query the processing resource status of the remote end NodeB. The establishment command is used to control the remote end NodeB to establish a processing task to share the load of the local NodeB. The modification command is used to adjust the processing task and processing resource allocation on the remote end NodeB. The release command is used to finish the processing task and release processing resources on the remote end NodeB. The allocation control command is used to configure a variety of attributes relating to the processing task on the remote end NodeB. The user plane data frame transmission mainly includes the downlink data frames forwarded from the RNC by the local NodeB, and the uplink data frames returned to the local NodeB which are formed by processing of the remote end NodeB, and in addition, the user plane may also include an in-band signalling control frame for purpose of the preact control, the time delay estimation of the wideband transmission link between the NodeBs and etc. One skilled in the art knows that besides the above method, there are other methods which are able to satisfy the timing requirement.

For the wireless BTS structure proposed according to the present invention for supporting processing resource sharing and load-sharing, there are a great variety of networking modes and load-sharing control policies.

According to the present invention, a possible networking mode is using plane structure, i.e., one BTS may connect to a plurality of adjacent BTSs, and then may perform the allocation control on the processing resources in the following manner: One method is to make the BSC/RNC to assume the control on the processing resource allocation and the load-sharing; Another method is to have the BTSs specifically configured with processing resource allocation management right to assume the control on the processing resource allocation and the load-sharing; a further method is to have the BTSs supporting processing resource sharing and load-sharing to perform the control on the processing resource allocation and the load-sharing through a certain dynamic negotiation procedure. The first method requires the BSC/RNC to obtain real time resource status of relevant BTSs, and therefore needs to change the original standardlized interface protocol between the BTS and the BSC/RNC; the second method is easier to implement; the third method is able to implement better processing resource allocation control, but has a greater implementation complexity.

In a word, the load-sharing control policy may be controlled by the BSC/RNC, or by one of the local BTS, the remote end BTS and other BTS(s), or through the negotiation between the BTSs, i.e., deciding the channel processing to be forwarded and the BTS which is in charge of sharing the forwarded channel processing. The local BTS and the remote end BTS perform channel processing forwarding and corresponding processing under the control of the load-sharing control policy.

In one embodiment, the load-sharing control policy may dynamically determine the channel processing to be forwarded and the BTS in charge of sharing the forwarded channel processing according to the traffic of the BTS and the amount of available channel processing resources of the BTS.

In one embodiment, when the channel processing resources of the local BTS are insufficient to complete its all channel processing, for example when a traffic peak occurs or some channel processing resources fail, the load-sharing control policy starts.

According to the present invention, another possible networking mode is using layered structure, i.e., one of a certain number of BTSs is configured as the load-sharing center having centralized channel processing resources, and relevant BTS processing resource allocation and load-sharing control are assumed by the center. The benefit of such a network structure is the simple control and the easy network planning and configuration.

According to the present invention, other kind of possible networking mode is to interconnect in pairs the geographically adjacent BTSs, as shown in FIG. 8. Each of the BTSs connects to its adjacent two BTSs through wideband point-to-point links such as optical fiber and etc., and the load of each of the BTSs may by shared by its adjacent two BTSs. since it has the same demand on the band width of the transmission links between the BTSs, and no routing operations such as addressing and etc. are needed, the structure has the feature of simple structure and easy implementation.

1. A wireless base station operatively connected to a wireless network control device, another wireless base station and a subscriber unit, comprising:
a first communication device for receiving downlink data frames from the wireless network control device and transmitting uplink data frames to the wireless network control device;
a second communication device for transmitting downlink wireless signals to the subscriber unit and receiving uplink wireless signals from the subscriber unit;
a channel processing device for processing the downlink data frames into the downlink wireless signals and processing the uplink wireless signals into the uplink data frames; and
a signal distribution unit for supplying the downlink data frames and the uplink wireless signals to the channel processing device for processing,
characterized in that,
the wireless base station further comprising a third communication device for communicating with the another wireless base station, and the signal distribution unit further comprising:
forwarding control means for transmitting the downlink data frames or uplink wireless signals to the another wireless base station and receiving corresponding downlink wireless signals or uplink data frames from the another wireless base station, through the third communication device.

2. The wireless base station of claim 1, characterized in that the forwarding control means is further configured to transmit frame timing information relating to the uplink wireless signals or downlink data frames transmitted to said another wireless base station to said another wireless base station.

3. The wireless base station of claim 2, characterized in that said frame timing information is the wireless base station local frame timing and the cell system frame timing information.

4. The wireless base station of claim 1, characterized in that the forwarding control means is further configured to advance the corresponding transmission by a time amount greater than or equal to the round trip transmission delay between said wireless base station and said another wireless base station, relative to the frame timing relating to the uplink wireless signals or downlink data frames transmitted to said another wireless base station.

5. The wireless base station of claim 1, characterized in that the forwarding control means is further configured to transmit the uplink wireless signals and downlink data frames to said another wireless base station, and receive corresponding downlink wireless signals and uplink data frames from said another wireless base station.

6. The wireless base station of claim 5, characterized in that said forwarded uplink wireless signals and said forwarded downlink data frames belong to the same physic channel.

7. The wireless base station of claim 1, characterized in that said forwarding control means is further configured to exchange control signaling with said another base station.

8. The wireless base station of claim 7, characterized in that said control signaling comprises channel processing resource query, allocation control, establishment, modification and release operating commands.

9. The wireless base station of claim 1, characterized in that said another base station is configurable, and said forwarding control means is further configured to perform transmission and reception to and from the configured another base station.

10. The wireless base station of claim 9, wherein said another wireless base station's configuration is decided by said wireless network control device, or said wireless base station, or said another wireless base station, or a third party wireless base station, or through the negotiation between wireless base stations.

11. A wireless base station system including a first base station, a second base station and a wireless network control device, said first base station comprising:
a first communication device for receiving downlink data frames from the wireless network control device and transmitting uplink data frames to the wireless network control device;
a second communication device for transmitting downlink wireless signals to the subscriber unit and receiving uplink wireless signals from the subscriber unit;
a channel processing device for processing the downlink data frames into the downlink wireless signals and processing the uplink wireless signals into the uplink data frames; and
a signal distribution unit for supplying the downlink data frames and the uplink wireless signals to the channel processing device for processing,
characterized in that,
the first base station further comprising a third communication device for communicating with the second base station, and the signal distribution unit further comprising:
forwarding control means for transmitting the downlink data frames or uplink wireless signals to the second base station and receiving corresponding downlink wireless signals or uplink data frames from the second base station, through the third communication device.

12. The base station system of claim 11, characterized in that the forwarding control means is further configured to transmit frame timing information relating to the uplink wireless signals or downlink data frames transmitted to said second base station to said second base station.

13. The base station system of claim 12, characterized in that said frame timing information is the wireless base station local frame timing and the cell system frame timing information.

14. The base station system of claim 11, characterized in that the forwarding control means is further configured to advance the corresponding transmission by a time amount greater than or equal to the round trip transmission delay between said first base station and said second base station, relative to the frame timing relating to the uplink wireless signals or downlink data frames transmitted to said second base station.

15. The base station system of claim 11, characterized in that the forwarding control means is further configured to transmit the uplink wireless signals and downlink data frames to said second base station, and receive corresponding downlink wireless signals and uplink data frames from said second base station.

16. The base station system of claim 15, characterized in that said forwarded uplink wireless signals and said forwarded downlink data frames belong to the same physic channel.

17. The base station system of claim 11, characterized in that said forwarding control means is further configured to exchange control signaling with said second base station.

18. The base station system of claim 17, characterized in that said control signaling comprises channel processing resource query, allocation control, establishment, modification and release operating commands.

19. The base station system of claim 11, characterized in that said second base station is configurable, and said forwarding control means is further configured to perform transmission and reception to and from the configured second base station.

20. The base station system of claim 19, wherein said second base station's configuration is decided by said wireless network control device, or said first base station, or said second wireless base station, or another base station, or through the negotiation between base stations.

21. A communication method in a wireless base station which is operatively connected to a wireless network control device, another wireless base station and a subscriber unit, the wireless base station comprising a first communication device, a second communication device, a channel processing device and a signal distribution unit, the method comprising steps:
receiving downlink data frames from the wireless network control device through the first communication device;
transmitting uplink data frames to the wireless network control device through the first communication device;
transmitting downlink wireless signals to the subscriber unit through the second communication device;
receiving uplink wireless signals from the subscriber unit through the second communication device;
supplying through the signal distribution unit the downlink data frames and the uplink wireless signals to the channel processing device for processing; and
processing the downlink data frames into the downlink wireless signals and processing the uplink wireless signals into the uplink data frames in the channel processing device,
wherein the wireless base station further comprising a third communication device for communicating with the another wireless base station, and the method is characterized in that the providing step further comprising:
transmitting the downlink data frames or the uplink wireless signal to the another wireless base station through the third communication device; and
receiving corresponding downlink wireless signals or uplink data frames from the another wireless base station through the third communication device.

22. A communication method in a wireless base station system, the wireless base station system comprising a first base station, a second base station and a wireless network control device, the first base station comprising a first communication device, a second communication device, a channel processing device and a signal distribution unit, wherein in the first base station:
receiving downlink data frames from the wireless network control device through the first communication device;
transmitting uplink data frames to the wireless network control device through the first communication device;
transmitting downlink wireless signals to the subscriber unit through the second communication device;
receiving uplink wireless signals from the subscriber unit through the second communication device;
supplying through the signal distribution unit the downlink data frames and the uplink wireless signals to the channel processing device for processing; and
processing the downlink data frames into the downlink wireless signals and processing the uplink wireless signals into the uplink data frames in the channel processing device,
wherein the first base station further comprising a third communication device for communicating with the second base station, and the method is characterized in that the providing step further comprising:
in the first base station, transmitting the downlink data frames or the uplink wireless signals to the second wireless base station through the third communication device; and
in the first base station, receiving corresponding downlink wireless signals or uplink data frames from the second base station through the third communication device.
